(19) United States
(12) Patent Application Publication
(10) Pub. No.: US 2021/0294349 A1
(43) Pub. Date: Sep. 23, 2021

(54) COMPUTATION DEVICE, VEHICLE, MATERIAL HANDLING SYSTEM, COMPUTATION METHOD, AND PROGRAM

(71) Applicant: MITSUBISHI HEAVY INDUSTRIES, LTD., Tokyo (JP)

(72) Inventors: Noriyuki HASEGAWA, Tokyo (JP); Naoto KAWAUCHI, Tokyo (JP); Kensuke FUTAHASHI, Tokyo (JP); Keitaro KAMATA, Tokyo (JP); Masayuki ISHIKAWA, Tokyo (JP)

(21) Appl. No.: 17/155,606

(22) Filed: Jan. 22, 2021

(30) Foreign Application Priority Data
Mar. 19, 2020 (JP) 2020-050041

(51) Int. Cl. G05D 1/02; G05D 1/00

(52) U.S. Cl. CPC G05D 1/0272; G05D 1/0223; G05D 2201/0216; G05D 1/0088; G05D 1/0214

(57) ABSTRACT

A computation device includes a first specifying unit configured to, based on a distance between a vehicle configured to autonomously travel and a pallet to be handled at a position on a first route on which the vehicle travels, specify a second route on which at least one of the vehicle and another vehicle different from the vehicle travels during material handling work that is related to the pallet and performed after the vehicle has traveled on the first route.

This application claims the benefit of priority to Japanese Patent Application Number 2020-050041 filed on Mar. 19, 2020. The entire contents of the above-identified application are hereby incorporated by reference.

### TECHNICAL FIELD

The present disclosure relates to a computation device, a vehicle, a material handling system, a computation method, and a program.

### RELATED ART

Industrial vehicles such as forklifts have features different from those of general passenger cars, such as the turning angle of wheels included in the vehicle body, and the structure of the vehicle. By taking advantage of such features of the vehicles, operations such as driving of and material handling by industrial vehicles are performed.

As a related technique, JP 6542574 describes a technique related to a system in which a two-dimensional laser radar is attached to a fork of a forklift, a three-dimensional distance image is generated by a lifting operation of the fork, and a pallet position is detected.

### SUMMARY

In industrial vehicles such as forklifts, development of autonomous driving technology is progressing, and there is a demand for technology capable of realizing efficient material handling work.

An object of the present disclosure is to provide a computation device, a vehicle, a material handling system, a computation method, and a program, which are capable of solving the above problems.

In order to solve the above-described problems, a computation device according to the present disclosure includes a first specifying unit configured to, based on a first route on which a vehicle configured to autonomously travel travels and a distance between the vehicle and a pallet to be handled at a position on the first route, specify a second route on which at least one of the vehicle and another vehicle different from the vehicle travels during material handling work that is related to the pallet and performed after the vehicle has traveled on the first route.

A vehicle according to the present disclosure includes the computation device described above, and an operating device that operates the vehicle based on a command from the computation device.

A material handling system according to the present disclosure includes the vehicle described above and a transport vehicle configured to autonomously change position based on the second route specified by the computation device of the vehicle, where the transport vehicle is different from the vehicle and different from the other vehicle.

A material handling system according to the present disclosure includes the vehicle described above, and the other vehicle that is different from the vehicle and that travels on the second route specified by the computation device of the vehicle.

A computation method according to the present disclosure includes, based on a distance between a vehicle configured to autonomously travel and a pallet to be handled at a position on a first route on which the vehicle travels, specifying a second route on which at least one of the vehicle and another vehicle different from the vehicle travels during material handling work that is related to the pallet and performed after the vehicle has traveled on the first route.

A program according to the present disclosure is configured to cause a computer to, based on a distance between a vehicle configured to autonomously travel and a pallet to be handled at a position on a first route on which the vehicle travels, execute specifying of a second route on which at least one of the vehicle and another vehicle different from the vehicle travels during material handling work that is related to the pallet and performed after the vehicle has traveled on the first route.

A computation device, a vehicle, a material handling system, a computation method, and a program, according to embodiments of the present disclosure can realize efficient material handling work.

### BRIEF DESCRIPTION OF DRAWINGS

The disclosure will be described with reference to the accompanying drawings, wherein like numbers reference like elements.

FIG. 1 is a diagram illustrating an example of a configuration of a material handling system according to a first embodiment of the present disclosure.

FIG. 2 is a diagram illustrating an example of a configuration of an industrial vehicle according to the first embodiment of the present disclosure.

FIG. 3 is a view for describing the movement of a fork of an industrial vehicle according to the first embodiment of the present disclosure.

FIG. 4 is a diagram for describing a pallet according to the first embodiment of the present disclosure.

FIG. 5 is a diagram for describing a relationship between a movement amount of an industrial vehicle and a detection distance according to the first embodiment of the present disclosure.

FIG. 6 is a diagram for describing a travel route during material handling work according to the first embodiment of the present disclosure.

FIG. 7 is a diagram illustrating an example of a configuration of a computation device according to a first embodiment of the present disclosure.

FIG. 8 is a diagram for describing height adjustment of the installation position of a distance measuring device 103 according to the first embodiment of the present disclosure.

FIG. 9 is a diagram illustrating an example of a processing flow of a material handling system according to the first embodiment of the present disclosure.

FIG. 10 is a first diagram for describing the processing flow of the material handling system according to the first embodiment of the present disclosure.

FIG. 11 is a second diagram for describing the processing flow of the material handling system according to the first embodiment of the present disclosure.

FIG. 12 is a third diagram for describing the processing flow of the material handling system according to the first embodiment of the present disclosure.

FIG. 13 is a diagram illustrating an example of a configuration of a material handling system according to a second embodiment of the present disclosure.

FIG. 14 is a diagram illustrating an example of a configuration of a computation device according to the second embodiment of the present disclosure.

FIG. 15 is a diagram illustrating an example of a configuration of a material handling system according to a third embodiment of the present disclosure.

FIG. 16 is a diagram illustrating an example of a configuration of a material handling system according to another embodiment of the present disclosure.

FIG. 17 is a schematic block diagram illustrating a configuration of a computer according to at least one embodiment.

### DESCRIPTION OF EMBODIMENTS

### First Embodiment

Hereinafter, a material handling system 1 according to a first embodiment of the present disclosure will be described.

Configuration of Material Handling System

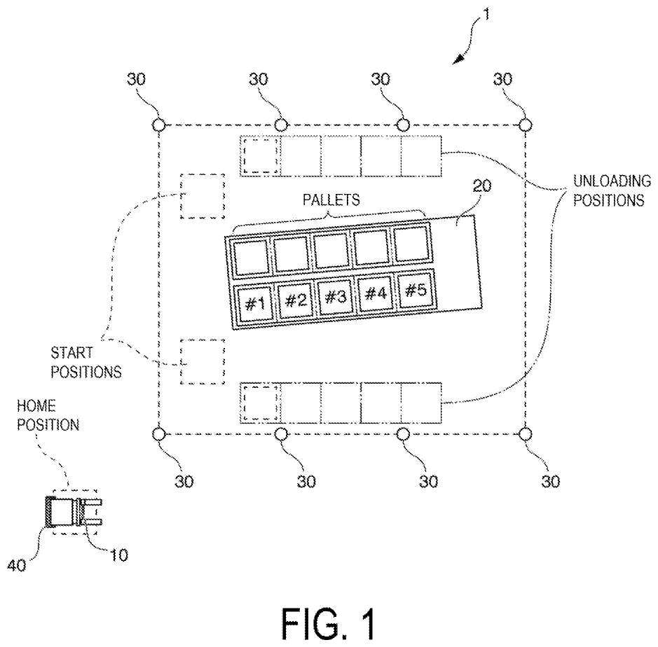

As illustrated in FIG. 1, the material handling system 1 includes an industrial vehicle 10 (an example of a vehicle), a truck 20, reflecting plates 30, and a charging device 40. The material handling system 1 is a system that specifies a state of pallets loaded on a truck 20 and specifies a travel route that enables efficient material handling work for the specified pallets according to the specified state of the pallets. The home position in FIG. 1 is, for example, a position for supplying electric power to the industrial vehicle 10 when the industrial vehicle 10 is an electrically operated vehicle. Further, the start position in FIG. 1 is a start position at which the industrial vehicle 10 starts material handling work.

Configuration of Industrial Vehicle

The industrial vehicle 10 is a vehicle that, when the state of a pallet is specified, specifies a route on which the industrial vehicle 10 travels based on the steering angle of the industrial vehicle 10, the traveling direction of the industrial vehicle 10, the vehicle speed of the industrial vehicle 10, the acceleration of the industrial vehicle 10, other detectable information of the industrial vehicle 10 (hereinafter, vehicle state), and the position of the industrial vehicle 10.

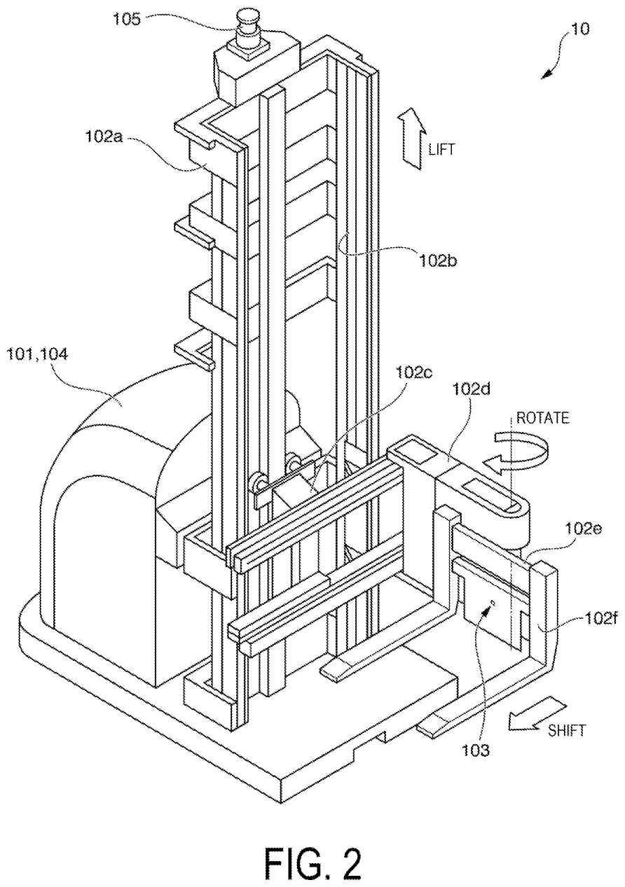

The industrial vehicle 10 is, for example, a forklift configured to autonomously travel as illustrated in FIG. 2. However, the industrial vehicle 10 may be a vehicle that performs a similar task. As illustrated in FIG. 2, the industrial vehicle 10 includes an operating device 101, a material handling mechanism 102, a distance measuring device 103, a computation device 104, and a two-dimensional laser radar 105. The two-dimensional laser radar 105 emits a laser beam and receives the laser beam reflected by the reflecting plates 30 to measure the distance to the reflecting plates 30. The industrial vehicle 10 is, for example, an electrically operated vehicle.

The operating device 101 is a device that receives, from the computation device 104, an operation for causing the industrial vehicle 10 to move or perform material handling work. For example, the operating device 101 operates a shift lever for determining forward/backward movement of the industrial vehicle 10, a steering portion for determining a steering angle of the industrial vehicle 10, an accelerator and a brake for adjusting the vehicle speed and acceleration of the industrial vehicle 10, or the like, in response to a command from the computation device 104.

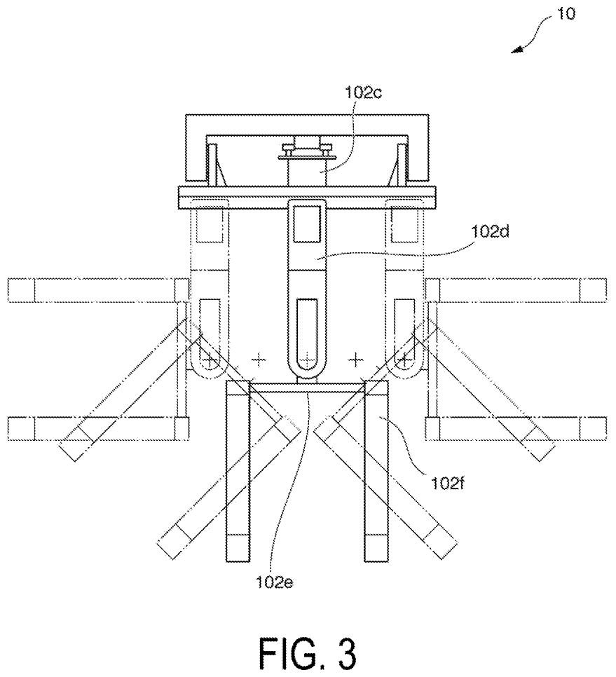

The material handling mechanism 102 includes an outer mast 102a, an inner mast 102b, a lift bracket 102c, a head 102d, a backrest 102e, and a fork 102f, as illustrated in FIG. 2. The material handling mechanism 102 including these components can lift, rotate, and shift, as illustrated in FIG. 2 in response to a command from the computation device 104, and can turn the fork 102f about 180 degrees to the left and right with respect to the travel direction as illustrated in FIG. 3.

The distance measuring device 103 is a device that measures the distance between the industrial vehicle 10 and an object. The distance measuring device 103 is, for example, a laser range finder, and is installed in the backrest 102e as illustrated in FIG. 3. In a case where the distance measuring device 103 is a laser range finder, the direction in which the laser is radiated is adjusted to be the same as the direction of the fork 102f (e.g., 90 degrees in the lateral direction with respect to the travel direction of the industrial vehicle 10) and is adjusted such that the laser is radiated at the same height as the height at which the laser range finder is installed (i.e., the horizontal direction). The object is a front surface of the pallet which is an object for material handling work.

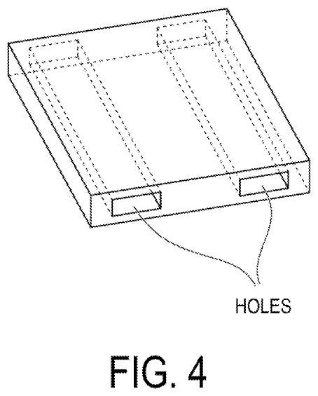

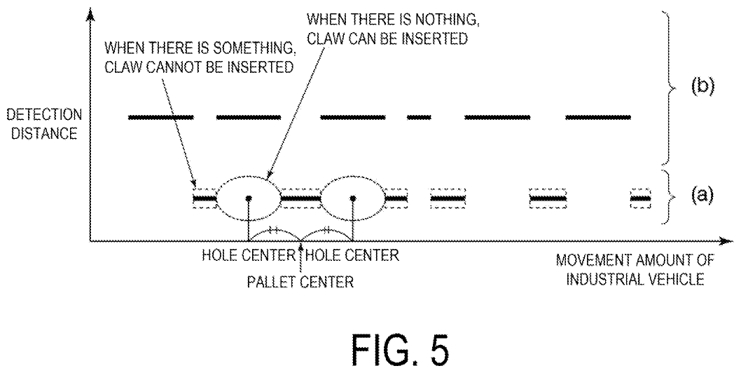

As illustrated in FIG. 4, the front surface of each pallet is, for example, provided with holes for inserting the fork 102f. Therefore, when all the pallets on the truck 20 are arranged in parallel and in a straight line with respect to the travel direction of the industrial vehicle 10 at the time of measuring the distance between the industrial vehicle 10 and the object, the measurement result by the distance measuring device 103 is within a specific set range for the front surface of the pallet as indicated by (a) in FIG. 5, and is a large value outside the specific range for other than the front surface of the pallet as indicated by (b) in FIG. 5.

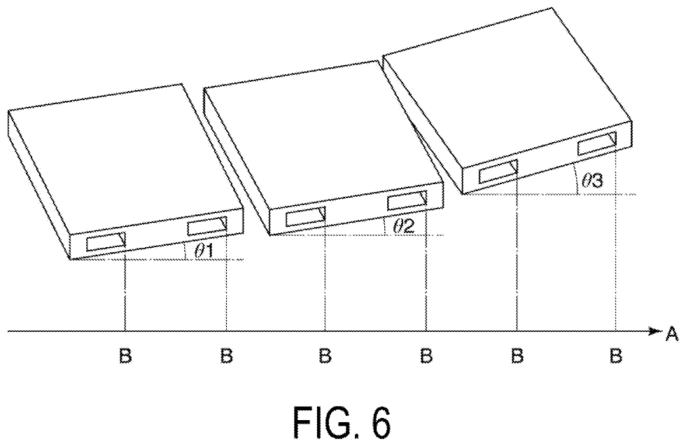

It should be noted that all the pallets on the truck 20 are not necessarily arranged in parallel and in a straight line with respect to the travel direction of the industrial vehicle 10 when the distance between the industrial vehicle 10 and an object is measured. Therefore, when the travel direction of the industrial vehicle 10 at the time of measuring the distance between the industrial vehicle 10 and an object is a direction A in FIG. 6, and each pallet is not placed parallel to the direction A as illustrated in FIG. 6, and the distance to the front surface of each pallet increases as the movement amount of the industrial vehicle 10 increases, the measurement result by the distance measuring device 103 takes minimal values at positions (positions B in FIG. 6) on the travel direction side of the industrial vehicle 10 in the holes or the gaps between the pallets. Although not illustrated, when the distance to the front surface of each pallet decreases as the movement amount of the industrial vehicle 10 increases, the measurement result by the distance measuring device 103 takes maximal values at positions on the opposite side to the travel direction of the industrial vehicle 10 in the holes or the gaps between the pallets (on the left side of the holes or the gaps between the pallets when the travel direction of the industrial vehicle 10 is the rightward direction).

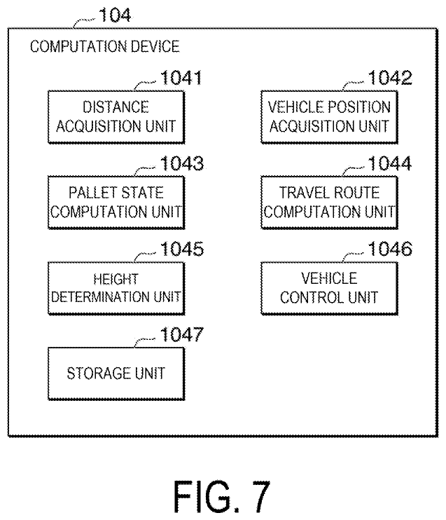

The computation device 104 is a device for specifying a travel route on which material handling work can be efficiently performed on the pallet. As illustrated in FIG. 7, the computation device 104 includes a distance acquisition unit 1041 (an example of an information acquisition unit), a vehicle position acquisition unit 1042, a pallet state computation unit 1043, a travel route computation unit 1044 (an example of a first specifying unit), a height determination unit 1045, a vehicle control unit 1046 (an example of a first control unit and an example of a second control unit), and a storage unit 1047.

The distance acquisition unit 1041 acquires the distance between the industrial vehicle 10 and an object. For example, the distance acquisition unit 1041 acquires, from the distance measuring device 103, the distance between the industrial vehicle 10 and an object measured by the distance measuring device 103.

The vehicle position acquisition unit 1042 acquires the position of the industrial vehicle 10. For example, each time the distance measuring device 103 measures the distance between the industrial vehicle 10 and an object, the vehicle position acquisition unit 1042 acquires, from the two-dimensional laser radar 105, the distance between the industrial vehicle 10 and each of the reflecting plates 30 measured by the two-dimensional laser radar 105. Then, the vehicle position acquisition unit 1042 specifies the position of the industrial vehicle 10, based on the acquired distance, and the position of each of the reflecting plates 30. An identifier is assigned to each of the reflecting plates 30 in advance. Additionally, the position of each of the reflecting plates 30 is known in advance. Therefore, the vehicle position acquisition unit 1042 can specify the position of the industrial vehicle 10 from the identifier of each of the reflecting plates 30, the position of each of the reflecting plates 30, and the distance between the industrial vehicle 10 and each of the reflecting plates 30.

The vehicle position acquisition unit 1042 records, in the storage unit 1047, the specified position of the industrial vehicle 10, and the distance between the industrial vehicle 10 and the object, in association with each other.

When the positions of the industrial vehicle 10 specified by the vehicle position acquisition unit 1042 are connected, a route (an example of a first route) is obtained on which the industrial vehicle 10 travels when the distance measuring device 103 measures the distance between the industrial vehicle 10 and an object.

The pallet state computation unit 1043 calculates the state of the pallet based on the position of the industrial vehicle 10 specified by the vehicle position acquisition unit 1042, the command from the computation device 104 to the operating device 101, and the distance acquired by the distance acquisition unit 1041. The state of the pallet is the position and orientation of the pallet.

As described with reference to FIGS. 5 and 6, the distance between the industrial vehicle 10 and an object measured by the distance measuring device 103 and the positions of the holes of the pallet have a relationship in which the distance measured at the positions of the holes of the pallet is longer. The interval between the pallets is narrower than the width of the holes. Therefore, for example, the pallet state computation unit 1043 compares the specified pattern of the movement amount and the detection distance of the industrial vehicle 10 with, for example, a pattern indicating a relationship between the movement amount and the detection distance of the industrial vehicle 10, which has been prepared in advance as illustrated in FIG. 5. When it is determined that both patterns coincide with each other within an allowable error range, the pallet state computation unit 1043 can specify the position of each pallet, the orientation of the pallet, and the positions of the holes of the pallet according to the pattern prepared in advance (that is, by determining that the aforementioned are the same as the front surface of the pallet, the positions of the holes of the pallet, and the gap between the pallets in the pattern prepared in advance).

The travel route computation unit 1044 calculates a route on which the industrial vehicle 10 travels when material handling work is to be performed for each pallet based on the position and the orientation of each pallet specified by the pallet state computation unit 1043.

For example, as illustrated in FIG. 6, when the distance measuring device 103 measures the distance between the industrial vehicle 10 and an object, the direction of the route traveled by the industrial vehicle 10 is set as a reference (0 degrees), and then, in a case where three pallets are shifted by angles θ1, θ2, and θ3, respectively, the travel route computation unit 1044 calculates the average value (θ1+θ2+θ3)/3 of the three angles and determines a route oriented at the calculated angle as the angle of the route on which the industrial vehicle 10 travels when material handling work is performed for each pallet. In addition, as illustrated in FIG. 5, the travel route computation unit 1044 further specifies a center position between the center positions of the two holes in each pallet, and determines the specified position as the center position of the pallet. Then, the travel route computation unit 1044 determines a route (an example of a second route) on which the industrial vehicle 10 travels when material handling work is to be performed so that, for example, the average value of the distances between the center positions of the pallets and the industrial vehicle 10 is a distance at which the industrial vehicle 10 can easily perform material handling work (e.g., a distance at which material handling work can be continuously performed on a plurality of materials by traveling with a small number of steering operations).

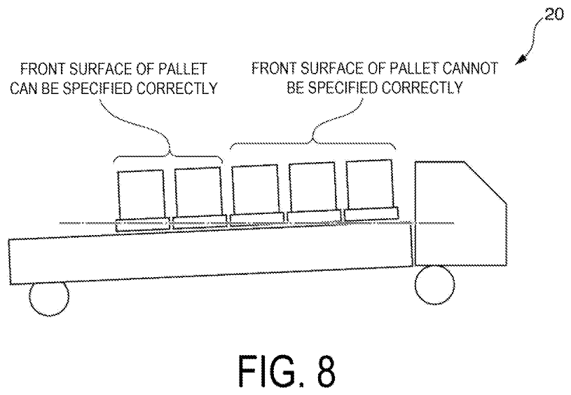

As illustrated in FIG. 8, depending on the material to be handled, the pallets loaded on the truck 20 may be inclined in the front-back direction of the truck 20. In a state where the pallets are inclined in the front-back direction of the truck 20, when the distance measuring device 103 is a laser range finder and the height at which the laser is radiated remains constant, the pallet state computation unit 1043 can correctly identify the front surface of each pallet for a while after the industrial vehicle 10 starts traveling. However, in due course, the height at which the laser is radiated and the height of the holes of the pallets do not match, and the pallet state computation unit 1043 may not be able to correctly specify the front surface of each pallet.

Therefore, in a case where the pallet state computation unit 1043 specifies that the pattern of the movement amount and the detection distance of the industrial vehicle 10 does not match the pattern indicating that there are two holes for each pallet, the height determination unit 1045 determines that it is necessary to change the height of the distance measuring device 103.

The vehicle control unit 1046 outputs, to the operating device 101, a command for operating the industrial vehicle 10.

For example, when the distance measuring device 103 measures the distance between the industrial vehicle 10 and an object, the vehicle control unit 1046 outputs, to the operating device 101, a command for causing the industrial vehicle 10 to travel on a predetermined route.

In addition, for example, in a case where the travel route computation unit 1044 determines a route on which the industrial vehicle 10 travels when material handling work is to be performed, the vehicle control unit 1046 outputs a command, to the operating device 101, for causing the industrial vehicle 10 to travel on the route.

In addition, for example, when the height determination unit 1045 determines that it is necessary to change the height of the distance measuring device 103, the vehicle control unit 1046 outputs, to the operating device 101, a command to return the industrial vehicle 10 to the last position where two holes could be specified. The vehicle control unit 1046 outputs a command, to the operating device 101, for moving the fork 102f in the vertical direction. When the fork 102f moves in the vertical direction, the pallet state computation unit 1043 specifies the center of the height of the front surface of a pallet in a case where the distance acquisition unit 1041 has acquired a distance approximately equal to the distance to the center position of the pallet for which two holes could be specified. Then, the vehicle control unit 1046 outputs a command to the operating device 101 such that the height of the distance measuring device 103 becomes the center of the height specified by the pallet state computation unit 1043.

The storage unit 1047 stores various types of information necessary for processing performed by the computation device 104. For example, the storage unit 1047 stores the position of the industrial vehicle 10, and the distance between the industrial vehicle 10 and the object, in association with each other.

The truck 20 is a truck for carrying material placed on a pallet to a place where the industrial vehicle 10 performs material handling work. In another embodiment, the truck 20 may be a truck for carrying material placed on a pallet from a place where the industrial vehicle 10 performs material handling work.

Each of the reflecting plates 30 is provided in a space where the industrial vehicle 10 performs material handling work, and reflects the laser beam emitted from the two-dimensional laser radar 105.

The charging device 40 is, for example, a device that supplies electric power to the industrial vehicle 10 when the industrial vehicle 10 is an electrically operated vehicle.

Processing Performed by Material Handling System

Next, the processing performed by the material handling system 1 will be described.

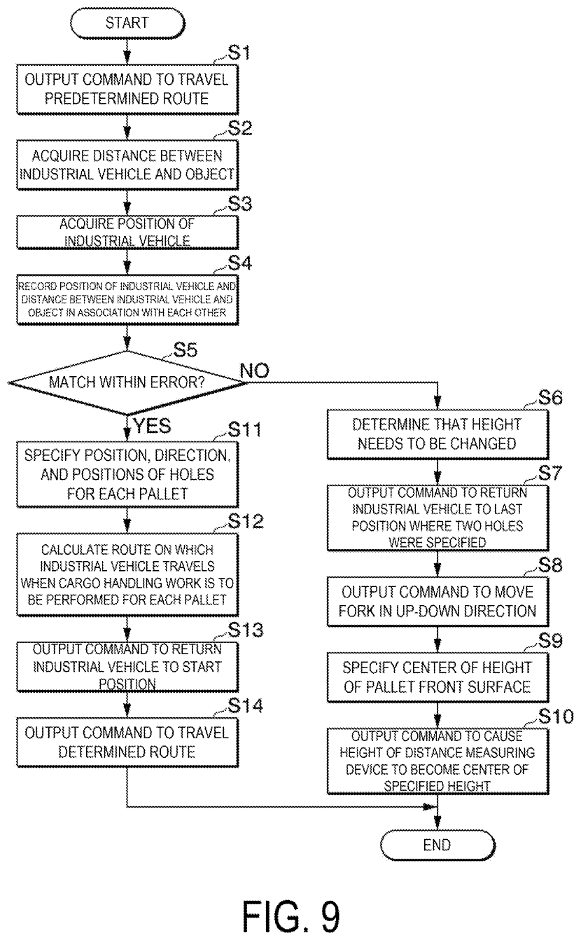

Here, a processing flow of the material handling system 1 when determining a route on which the industrial vehicle 10 travels when material handling work is to be performed on each pallet illustrated in FIG. 9 will be described.

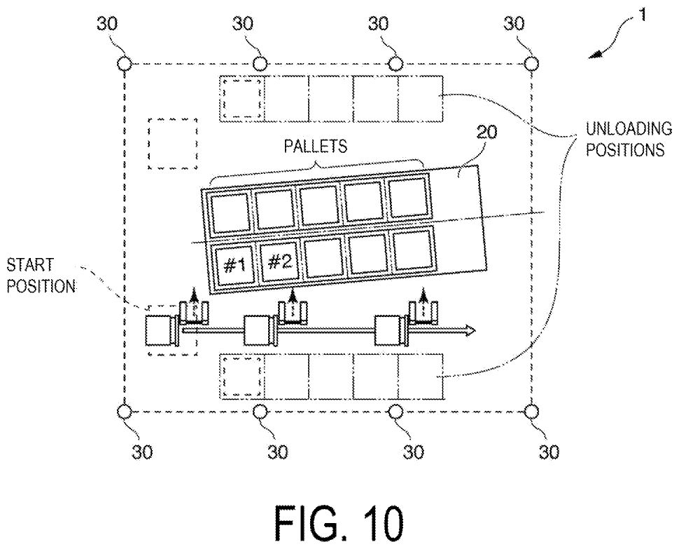

Here, the processing of the material handling system 1 will be described under the assumption that the industrial vehicle 10 travels from the start position illustrated in FIG. 10 and that, at the start position, the height of the distance measuring device 103 is adjusted to a height obtained by adding one half of the height of a pallet to the height of a loading platform of the truck 20 on which the pallet is placed. Examples of methods for adjusting the height of the distance measuring device 103 to the height obtained by adding one half of the height of the pallet to the height of the loading platform of the truck 20 on which the pallet is placed include methods in which a person manually inputs a set value of the height and methods such as steps S7 to S10 described later.

The vehicle control unit 1046 outputs a command, to the operating device 101, for causing the industrial vehicle 10 to travel on a predetermined route (step S1). The predetermined route is, for example, a route in a direction along unloading positions as illustrated in FIG. 10.

The distance acquisition unit 1041 acquires the distance between the industrial vehicle 10 and an object (step S2).

The vehicle position acquisition unit 1042 acquires the position of the industrial vehicle 10 (step S3). The vehicle position acquisition unit 1042 records, in the storage unit 1047, the acquired position of the industrial vehicle 10 and the distance between the industrial vehicle 10 and the object acquired by the distance acquisition unit 1041, in association with each other (step S4).

The pallet state computation unit 1043 calculates the state of the pallet, based on the position of the industrial vehicle 10 specified by the vehicle position acquisition unit 1042, the command from the computation device 104 to the operating device 101, and the distance acquired by the distance acquisition unit 1041.

For example, the pallet state computation unit 1043 compares the specified pattern of the movement amount and the detection distance of the industrial vehicle 10 with, for example, a pattern that is prepared in advance and that indicates a relationship between the movement amount and the detection distance of the industrial vehicle 10 as illustrated in FIG. 5. The pallet state computation unit 1043 determines whether both patterns match within an allowable error range (step S5).

When the pallet state computation unit 1043 determines that both patterns do not match (NO in step S5), the height determination unit 1045 determines that the height of the distance measuring device 103 needs to be changed (step S6).

The vehicle control unit 1046 outputs a command to the operating device 101 to return the industrial vehicle 10 to the last position where two holes could be specified (step S7). The vehicle control unit 1046 outputs a command, to the operating device 101, for moving the fork 102f in the vertical direction (step S8).

When the fork 102f moves in the vertical direction, the pallet state computation unit 1043 specifies the center of the height of the front surface of the pallet in a case where the distance acquisition unit 1041 acquires a distance approximately equal to the center position of the pallet for which two holes could be specified (step S9).

The vehicle control unit 1046 outputs a command to the operating device 101 so that the height of the distance measuring device 103 becomes the center of the height specified by the pallet state computation unit 1043 (step S10).

When the pallet state computation unit 1043 determines that both patterns match (YES in step S5), the pallet state computation unit 1043 specifies the position of each pallet, the orientation of the pallet, and the positions of the holes of the pallet in accordance with a pattern prepared in advance (step S11).

The travel route computation unit 1044 calculates a route on which the industrial vehicle 10 travels when material handling work is to be performed for each pallet, based on the position and the orientation of each pallet identified by the pallet state computation unit 1043 (step S12).

For example, the travel route computation unit 1044 calculates the average value of the angles of the respective pallets with the direction of the route traveled by the industrial vehicle 10 as a reference (0 degrees) when the distance measuring device 103 has measured the distance between the industrial vehicle 10 and an object, and determines a route oriented at the calculated angle as the angle of the route traveled by the industrial vehicle 10 when material handling work is to be performed for each pallet. In addition, the travel route computation unit 1044 determines a route on which the industrial vehicle 10 travels when material handling work is to be performed so that, for example, the average value of the distances between the center positions of the pallets and the industrial vehicle 10 is a distance at which the industrial vehicle 10 can easily perform material handling work (e.g., a distance at which material handling work can be continuously performed on a plurality of materials by traveling with a small number of steering operations).

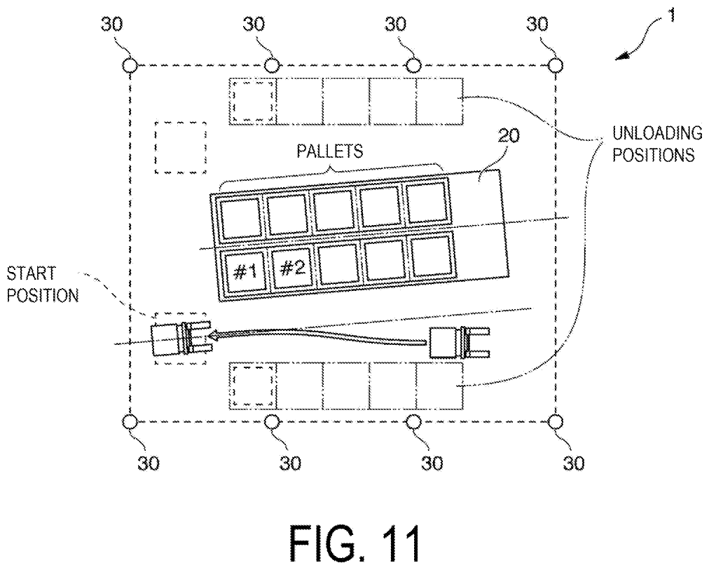

As illustrated in FIG. 11, the vehicle control unit 1046 outputs a command, to the operating device 101, for returning the industrial vehicle 10 to the start position (step S13). At this time, the command output by the vehicle control unit 1046 to the operating device 101 is a command for setting the orientation of the industrial vehicle 10 at the start position to the orientation of the route determined by the travel route computation unit 1044.

Then, the vehicle control unit 1046 outputs a command, to the operating device 101, for causing the vehicle to travel on the route determined by the travel route computation unit 1044 (step S14).

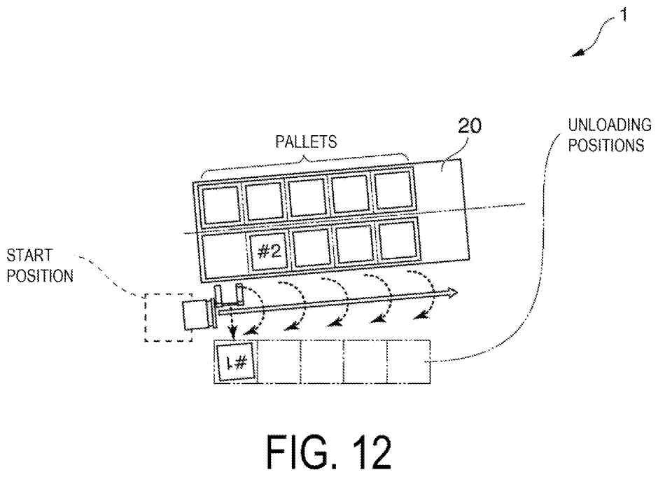

The industrial vehicle 10 executes, for example, material handling work as illustrated in FIG. 12 in response to the command to travel on the route determined by the travel route computation unit 1044.

Operational Effects

The material handling system 1 according to the first embodiment of the present disclosure has been described above.

In the computation device 104, when the distance measuring device 103 has measured the distance between the industrial vehicle 10 and an object, based on the distances between the industrial vehicle 10 and the pallets to be handled at respective positions on the route on which the industrial vehicle 10 has traveled, the travel route computation unit 1044, after the industrial vehicle 10 has traveled on the route, specifies a route to be traveled by the industrial vehicle 10 during material handling work related to the pallets to be handled.

In this way, the computation device 104 can specify a route on which the industrial vehicle 10 can easily perform material handling work, and can realize efficient material handling work.

### Second Embodiment

Next, a material handling system 1 according to a second embodiment of the present disclosure will be described.

Configuration of Material Handling System

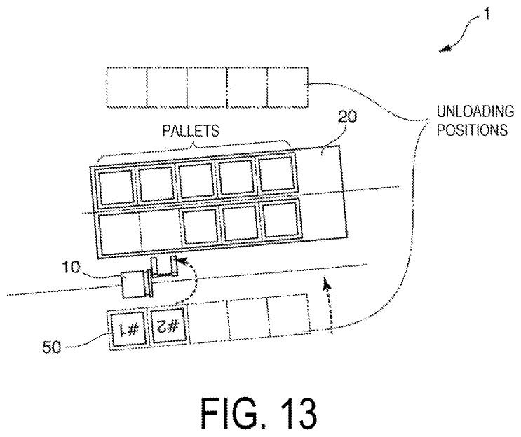

The material handling system 1 includes the industrial vehicle 10, the truck 20, the reflecting plates 30, the charging device 40, and an omni-mobile temporary placement table 50 (an example of a transport vehicle). FIG. 13 is an example of a diagram illustrating a material handling system 1 according to the second embodiment of the present disclosure. However, in FIG. 13, the reflecting plates 30 and the charging device 40 are omitted.

The industrial vehicle 10 is, for example, a forklift configured to autonomously travel. However, the industrial vehicle 10 may be a vehicle that performs a similar task.

The industrial vehicle 10 includes the operating device 101, the material handling mechanism 102, the distance measuring device 103, and the computation device 104. Further, the industrial vehicle 10 also includes the two-dimensional laser radar 105 (not illustrated). The two-dimensional laser radar 105 emits a laser beam and receives the laser beam reflected by one of the reflecting plates 30 to measure the distance to the reflecting plate 30.

The industrial vehicle 10 is, for example, an electrically operated vehicle.

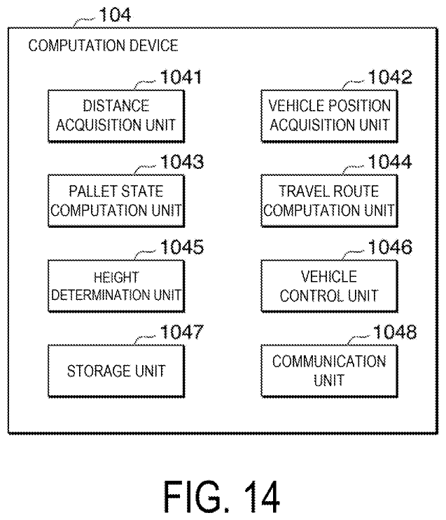

The computation device 104 is a device for specifying a travel route on which material handling work can be efficiently performed on the pallet. As illustrated in FIG. 14, the computation device 104 includes the distance acquisition unit 1041, the vehicle position acquisition unit 1042, the pallet state computation unit 1043, the travel route computation unit 1044, the height determination unit 1045, the vehicle control unit 1046, the storage unit 1047, and a communication unit 1048.

The communication unit 1048 transmits to the omni-mobile temporary placement table 50, information on the route, which is calculated by the travel route computation unit 1044 and on which the industrial vehicle 10 travels when material handling work is to be performed on each pallet.

The omni-mobile temporary placement table 50 is a temporary placement table configured to autonomously travel, and based on information on the route, which is calculated by the travel route computation unit 1044 and on which the industrial vehicle 10 travels when material handling work is to be performed on each pallet, the omni-mobile temporary placement table 50 moves to a position and an orientation parallel to the route. Then, the omni-mobile temporary placement table 50 conveys the loaded material to a place where the next process is performed.

### Operational Effects

The material handling system 1 according to the second embodiment of the present disclosure has been described above. The material handling system 1 includes the omni-mobile temporary placement table 50. In the material handling system 1, the communication unit 1048 transmits to the omni-mobile temporary placement table 50, information on the route, which is calculated by the travel route computation unit 1044 and on which the industrial vehicle 10 travels when material handling work is to be performed on each pallet.

Based on information on the route, which is calculated by the travel route computation unit 1044 and on which the industrial vehicle 10 travels when material handling work is to be performed on each pallet, the omni-mobile temporary placement table 50 moves to a position and an orientation parallel to the route, so that the unloading position becomes substantially parallel to the pallet and the travel route of the industrial vehicle 10 during material handling work. Therefore, the material handling system 1 according to the second embodiment of the present disclosure can perform material handling work more efficiently than the material handling system 1 according to the first embodiment of the present disclosure.

### Third Embodiment

Next, a material handling system 1 according to a third embodiment of the present disclosure will be described.

Configuration of Material Handling System

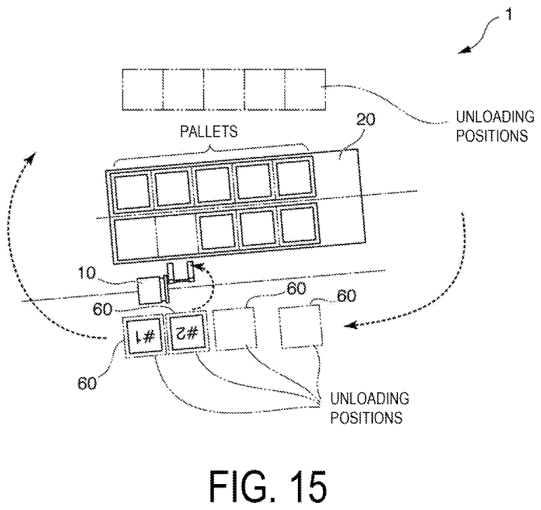

The material handling system 1 includes the industrial vehicle 10, the truck 20, the reflecting plates 30, the charging device 40, and an automated guided vehicle (AGV) 60 (an example of a transport vehicle). FIG. 15 is an example of a diagram illustrating the material handling system 1 according to the third embodiment of the present disclosure. However, in FIG. 15, the reflecting plates 30 and the charging device 40 are omitted.

The industrial vehicle 10 is, for example, a forklift configured to autonomously travel. However, the industrial vehicle 10 may be a vehicle that performs a similar task.

The industrial vehicle 10 includes the operating device 101, the material handling mechanism 102, the distance measuring device 103, and the computation device 104. The industrial vehicle 10 also includes the two-dimensional laser radar 105 (not illustrated). The two-dimensional laser radar 105 emits a laser beam and receives the laser beam reflected by the reflecting plates 30 to measure the distance to the reflecting plates 30.

The industrial vehicle 10 is, for example, an electrically operated vehicle.

The computation device 104 is a device for specifying a travel route on which material handling work can be efficiently performed on the pallet. The computation device 104 includes the distance acquisition unit 1041, the vehicle position acquisition unit 1042, the pallet state computation unit 1043, the travel route computation unit 1044, the height determination unit 1045, the vehicle control unit 1046, the storage unit 1047, and the communication unit 1048.

The communication unit 1048 transmits to the AGV 60, information on the route, which is calculated by the travel route computation unit 1044 and on which the industrial vehicle 10 travels when material handling work is to be performed on each pallet.

Based on information on the route, which is calculated by the travel route computation unit 1044 and on which the industrial vehicle 10 travels when material handling work is to be performed on each pallet, the AGV 60 is a transport vehicle that is configured to autonomously travel and that moves to a position and an orientation parallel to the route. Then, the AGV 60 transports the loaded material to a place where the next process is performed.

Operational Effects

The material handling system 1 according to the third embodiment of the present disclosure has been described above.

The material handling system 1 includes the AGV 60. In the material handling system 1, the communication unit 1048 transmits to the AGV 60, information on the route, which is calculated by the travel route computation unit 1044 and on which the industrial vehicle 10 travels when material handling work is to be performed on each pallet.

Based on information on the route, which is calculated by the travel route computation unit 1044 and on which the industrial vehicle 10 travels when material handling work is to be performed on each pallet, the AGV 60 moves to a position and in an orientation parallel to the route, so that the unloading position becomes substantially parallel to the pallet and the travel route of the industrial vehicle 10 during material handling work. Therefore, the material handling system 1 according to the third embodiment of the present disclosure can perform material handling work more efficiently than the material handling system 1 according to the first embodiment of the present disclosure.

In addition, in the material handling system 1 according to the third embodiment of the present disclosure, the AGV 60 can immediately move to a place where the next process is performed each time one material is loaded. Therefore, the material handling system 1 according to the third embodiment of the present disclosure can advance to the next process faster than the material handling system 1 according to the second embodiment of the present disclosure.

In the first to third embodiments of the present disclosure, the processing of the material handling system 1 has been described when unloading the material loaded on the truck 20. However, in the material handling system 1 according to another embodiment of the present disclosure, the travel route when loading material placed in a temporary storage place, a temporary placement table, or the like may be calculated based on the same idea as that of the material handling system 1 according to the first to third embodiments of the present disclosure.

In the material handling system 1 according to the first to third embodiments of the present disclosure, it is described that the position of the industrial vehicle 10 is specified by using the two-dimensional laser radar 105 and the reflecting plates 30. However, in the material handling system 1 according to another embodiment of the present disclosure, a rotary encoder may be attached to a travel mechanism of the industrial vehicle 10, and the position of the industrial vehicle 10 may be specified based on information of the rotary encoder and a command that is related to steering and that is received by the operating device 101 of the industrial vehicle 10 from the computation device 104.

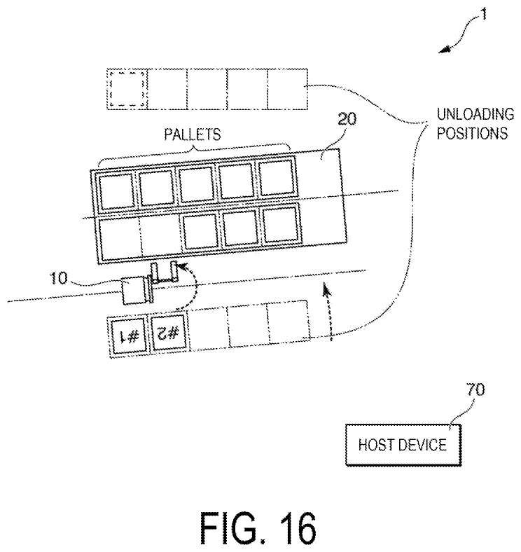

In the material handling system 1 according to the second and third embodiments of the present disclosure, the computation device 104 includes the communication unit 1048, and the communication unit 1048 transmits to the omni-mobile temporary placement table 50 or the AGV 60, the information on the route, which is calculated by the travel route computation unit 1044 and on which the industrial vehicle 10 travels when material handling work is to be performed on each pallet. However, as illustrated in FIG. 16, the material handling system 1 according to another embodiment of the present disclosure may include a host device 70, and the host device 70 may transmit to the omni-mobile temporary placement table 50 or the AGV 60, information on a route, which has been calculated by the travel route computation unit 1044 and on which the industrial vehicle 10 travels when material handling work is to be performed on each pallet.

In addition, the material handling system 1 according to another embodiment of the present disclosure may further include an industrial vehicle 10a different from the industrial vehicle 10, and may perform the same material handling work as the industrial vehicle 10 based on the route, which has been calculated by the travel route computation unit 1044, and on which the industrial vehicle 10 travels when material handling work is to be performed on each pallet. The industrial vehicles 10 and 10a may perform material handling work in parallel.

In the material handling system 1 according to another embodiment of the present disclosure, the industrial vehicle 10 may control the material handling work of another industrial vehicle 10a.

For example, the industrial vehicle 10a may include the communication unit 1048 instead of the computation device 104, and the operating device 101 may operate the industrial vehicle 10a in response to a command transmitted from the industrial vehicle 10.

The order of the processes in the embodiments of the present disclosure may be changed as long as appropriate processes are performed.

Each of the storage unit 1047 and the other storage devices in the embodiment of the present disclosure may be provided anywhere within a range in which appropriate information is transmitted and received. Each of the storage unit 1047 and the other storage devices may include a plurality of storage devices and store data in a distributed manner within a range in which appropriate information is transmitted and received.

Although the embodiments of the present disclosure have been described, the charging device 40, the omni-mobile temporary placement table 50, the AGV 60, the host device 70, the operating device 101, the distance measuring device 103, the computation device 104, and other control devices may include a computer system therein. The processes described above are stored in a computer-readable recording medium in the form of a program, and the processes are performed by a computer reading and executing the program. A specific example of the computer is illustrated below.

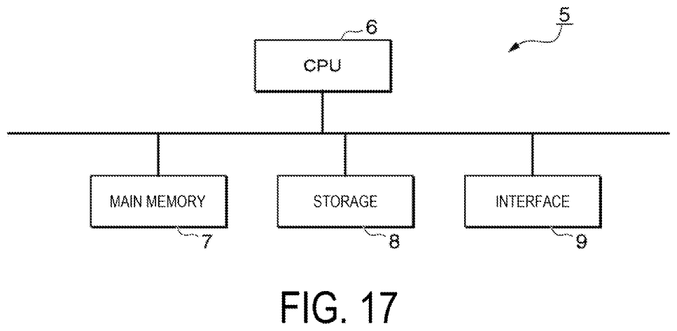

FIG. 17 is a schematic block diagram illustrating a configuration of a computer according to at least one embodiment.

As illustrated in FIG. 17, the computer 5 includes a CPU 6, a main memory 7, a storage 8, and an interface 9. For example, each of the charging device 40, the omni-mobile temporary placement table 50, the AGV 60, the host device 70, the operating device 101, the distance measuring device 103, the computation device 104, and other control devices is mounted on the computer 5. The operation of each processing unit described above is stored in the storage 8 in the form of a program. The CPU 6 reads a program from the storage 8, develops the program in the main memory 7, and executes the above-described processing in accordance with the program. In addition, CPU 6 secures a storage area corresponding to each of the above-described storage units in the main memory 7 according to the program.

Examples of the storage 8 include a hard disk drive (HDD), a solid state drive (SSD), a magnetic disk, a magneto-optical disk, a compact disc read only memory (CD-ROM), a digital versatile disc read only memory (DVD-ROM), and a semiconductor memory. The storage 8 may be an internal medium directly connected to the bus of the computer 5 or an external medium connected to the computer 5 via the interface 9 or a communication line. When the program is distributed to the computer 5 via a communication line, the computer 5 that received the program may develop the program in the main memory 7 and execute the above-described processing. In at least one embodiment, the storage 8 is a non-transitory tangible storage medium.

The program may realize some of the above-described functions. Further, the program may be a so-called differential file (differential program), which can realize the above-mentioned functions in combination with a program already recorded in the computer system.

In another embodiment, each of the computation device 104 and the other control devices may include a custom large-scale integrated circuit (LSI) such as a programmable logic device (PLD), an application specific integrated circuit (ASIC), a graphics processing unit (GPU), or a processing device similar thereto, in addition to or instead of the above-described configuration. Examples of the PLD include a programmable array logic (PAL), a generic array logic (GAL), a complex programmable logic device (CPLD), and a field programmable gate array (FPGA). In this case, some or all of the functions implemented by the processor may be implemented by the integrated circuit.

While certain embodiments have been described, these embodiments have been presented by way of example only, and are not intended to limit the scope of the disclosure. Various additions, omissions, substitutions, and modifications may be made to these embodiments without departing from the scope of the disclosure.

### Notes

The computation device 104, the industrial vehicle 10 (an example of a vehicle), the material handling system 1, the computation method, and the program, according to each embodiment of the present disclosure are, for example, grasped as follows.

(1) A computation device (104) according to a first aspect includes a first specifying unit (1044) configured to, based on a distance between a vehicle (10) configured to autonomously travel and pallet to be handled at a position on a first route on which the vehicle (10) travels, specify a second route on which at least one of the vehicle (10) and another vehicle (10a) different from the vehicle (10) travels during material handling work that is related to the pallet and performed after the vehicle (10) has traveled on the first route.

The computation device (104) can specify a route on which the vehicle (10) can easily perform material handling work, thereby achieving efficient material handling work.

(2) A computation device (104) according to a second aspect may be the computation device (104) of (1), and may include a first control unit (1046) configured to cause at least one of the vehicle (10) and the other vehicle (10a) to travel on the second route.

The computation device (104) specifies a route on which the vehicle (10) can easily perform the material handling work, and allows at least one of the vehicle (10) and the other vehicle (10a) to travel on the specified route, thereby achieving efficient material handling work.

(3) A computation device (104) according to a third aspect may be the computation device (104) of (1) or (2), and may include an information acquisition unit (1041) configured to acquire, from a distance measuring device (103), information on the distance, and the first specifying unit (1044) may specify the second route based on the information on the distance acquired by the information acquisition unit (1041).

The computation device (104) can specify a route on which the vehicle (10) can easily perform material handling work, thereby achieving efficient material handling work.

(4) A computation device (104) according to a fourth aspect may be the computation device (104) of (3), and may include a second control unit (1046) configured to control a height of the distance measuring device (103) based on the distance.

The computation device (104) can specify a route on which the vehicle (10) can easily perform material handling work, and can more reliably specify the positions of holes of the pallet, thereby achieving efficient material handling work.

(5) A computation device (104) according to a fifth aspect may be the computation device (104) of any one of (1) to (4), and may include a communication unit (1048) configured to enable the other vehicle (10a) different from the vehicle (10) to acquire information on the second route.

The computation device (104) can specify a route on which the vehicle (10) can easily perform material handling work, and enables the other vehicle (10a) to perform the material handling work, thereby achieving efficient material handling work.

(6) A vehicle (10) according to a sixth aspect includes the computation device (104) according to any one of (1) to (4), and an operating device configured to operate the vehicle based on a command from the computation device (104).

The vehicle (10) can specify a route on which the vehicle (10) can easily perform material handling work, thereby achieving efficient material handling work.

(7) A material handling system (1) according to a seventh aspect includes the vehicle (10) of (6), and a transport vehicle (50, 60) configured to autonomously change a position based on the second route specified by the computation device (104) of the vehicle (10), where the transport vehicle (50, 60) is different from the vehicle (10) and different from the other vehicle (10a).

The material handling system (1) can specify a route on which the vehicle (10) can easily perform material handling work, and can achieve more efficient material handling work than in a case where the transport vehicle (50, 60) is not used.

(8) A material handling system (1) according to an eighth aspect includes the vehicle (10) of (6), and the other vehicle (10a) configured to travel along the second route specified by the computation device (104) of the vehicle (10).

The material handling system (1) can specify a route on which the vehicle (10) can easily perform material handling work, and can achieve more efficient material handling work than in a case where the transport vehicle (50, 60) is not used.

(9) A material handling system (1) according to a ninth aspect is the material handling system (1) of (8), and may include a transport vehicle (50, 60) configured to autonomously change position based on the second route specified by the computation device (104) of the vehicle (10), where the transport vehicle (50, 60) is different from the vehicle (10) and different from the other vehicle (10a).

The material handling system (1) can specify a route on which the vehicle (10) can easily perform material handling work, and can achieve more efficient material handling work than in a case where the transport vehicle (50, 60) is not used.

(10) A computation method according to a tenth aspect includes, based on a distance between a vehicle (10) configured to autonomously travel and a pallet to be handled at a position on a first route on which the vehicle (10) travels, specifying a second route on which at least one of the vehicle (10) and another vehicle (10a) different from the vehicle (10) travels during material handling work that is related to the pallet and performed after the vehicle (10) has traveled on the first route.

The computation method can specify a route on which the vehicle (10) can easily perform material handling work, thereby achieving efficient material handling work.

(11) A program according to an eleventh aspect is configured to cause a computer to, based on a distance between a vehicle (10) configured to autonomously travel and a pallet to be handled at a position on a first route on which the vehicle (10) travels, execute specifying of a second route on which at least one of the vehicle (10) and another vehicle (10a) different from the vehicle (10) travels during material handling work that is related to the pallet and performed after the vehicle (10) has traveled on the first route.

The program can specify a route on which the vehicle (10) can easily perform material handling work, thereby achieving efficient material handling work.

While preferred embodiments of the invention have been described as above, it is to be understood that variations and modifications will be apparent to those skilled in the art without departing from the scope and spirits of the invention. The scope of the invention, therefore, is to be determined solely by the following claims

1. A computation device, comprising:
a first specifying unit configured to, based on a distance between a vehicle configured to autonomously travel and a pallet to be handled at a position on a first route on which the vehicle travels, specify a second route on which at least one of the vehicle and another vehicle different from the vehicle travels during material handling work that is related to the pallet and performed after the vehicle has traveled on the first route.

2. The computation device according to claim 1, further comprising:
a first control unit configured to cause at least one of the vehicle and the other vehicle to travel on the second route.

3. The computation device according to claim 1, further comprising:
an information acquisition unit configured to acquire information on the distance from a distance measuring device,
wherein the first specifying unit specifies the second route based on the information on the distance acquired by the information acquisition unit.

4. The computation device according to claim 3, further comprising:
a second control unit configured to control a height of the distance measuring device based on the distance.

5. The computation device according to claim 1, further comprising:
a communication unit configured to enable the other vehicle to acquire information on the second route.

6. A vehicle, comprising:
the computation device according to claim 1; and
an operating device configured to operate the vehicle based on a command from the computation device.

7. A material handling system, comprising:
the vehicle according to claim 6; and
a transport vehicle configured to autonomously change position based on the second route specified by the computation device of the vehicle, the transport vehicle being different from the vehicle and different from the other vehicle.

8. A material handling system, comprising:
the vehicle according to claim 6; and
the other vehicle configured to travel along the second route specified by the computation device of the vehicle.

9. The material handling system according to claim 8, further comprising:
a transport vehicle configured to autonomously change position based on the second route specified by the computation device of the vehicle, the transport vehicle being different from the vehicle and different from the other vehicle.

10. A computation method, comprising:
based on a distance between a vehicle configured to autonomously travel and a pallet to be handled at a position on a first route on which the vehicle travels, specifying a second route on which at least one of the vehicle and other vehicle different from the vehicle travels during material handling work that is related to the pallet and performed after the vehicle has traveled on the first route.

11. A non-transitory computer readable medium storing a program, configured to cause a computer to,
based on a distance between a vehicle configured to autonomously travel and a pallet to be handled at a position on a first route on which the vehicle travels, execute specifying of a second route on which at least one of the vehicle and other vehicle different from the vehicle travels during material handling work that is related to the pallet and performed after the vehicle has traveled on the first route.
